(19) United States
(12) Patent Application Publication
(10) Pub. No.: US 2026/0351459 A1
(43) Pub. Date: Nov. 5, 2026

(54) METHODS, DEVICES, AND SYSTEMS FOR MULTIPHASE COUPLED INDUCTORS

(71) Applicants: The Trustees of Princeton University, Princeton, NJ (US); Murata Manufacturing Co., Ltd., Kyoto (JP)

(72) Inventors: Minjie Chen, Princeton, NJ (US); Ping Wang, Princeton, NJ (US); Gregory Szczeszynski, Nashua, NH (US)

(21) Appl. No.: 19/711,833

(22) Filed: Jun. 17, 2026

Related U.S. Application Data
(63) Continuation of application No. PCT/US2024/060872, filed on Dec. 18, 2024.
(60) Provisional application No. 63/612,761, filed on Dec. 20, 2023.

(51) Int. Cl. H01F 27/24; H01F 27/28

(52) U.S. Cl. CPC H01F 27/24; H01F 27/28

(57) ABSTRACT

The present disclosure relates to systems and methods for multiphase coupled inductors. In some embodiments, a multiphase coupled inductor may include a magnetic ladder core assembly. The magnetic ladder core assembly may include: a first row of at least one rung, wherein an electrically conductive winding is wound around each rung of the at least one rung, forming a first row of electrical windings along a first direction; a second row of at least one rung, wherein an electrically conductive winding is wound around each rung of the at least one rung, forming a second row of electrical windings along the first direction; and a middle rail having a width along a second direction normal to the first direction, separating the first and the second row of electrical windings.

### CROSS REFERENCE TO RELATED APPLICATIONS

This application is a continuation of International Patent Application No. PCT/US2024/060872 filed Dec. 18, 2024 and entitled “METHODS, DEVICES, AND SYSTEMS FOR MULTIPHASE COUPLED INDUCTORS,” which claims the benefit of and priority to U.S. Provisional Patent Application No. 63/612,761 filed Dec. 20, 2023 and entitled “METHODS, DEVICES, AND SYSTEMS FOR MULTIPHASE COUPLED INDUCTORS,” all of which are incorporated herein by reference in their entirety.

### TECHNICAL FIELD

The present disclosure generally relates to power electronic devices. More particularly, the present disclosure relates to multiphase coupled inductors.

### BACKGROUND

Many electronic products, particularly mobile computing and/or communication products and components (e.g., notebook computers, ultra-book computers, tablet devices, LCD and LED displays), require multiple DC (direct current) voltage levels. For example, radio frequency transmitter power amplifiers may require relatively high voltages (e.g., 12V or more), and logic circuitry may require a low voltage level (e.g., 1-2V). Some other circuitries may require an intermediate voltage level (e.g., 5-10V). Power converters are often used to generate a lower or higher voltage from a common power source, such as a battery, in order to meet the power requirements of different components in the electronic products.

### SUMMARY

Embodiments of the present disclosure provide a multiphase coupled inductor. Disclosed embodiments may include a magnetic ladder core assembly. The magnetic ladder core assembly may have a first row of at least one rung, wherein an electrically conductive winding is wound around each rung of the at least one rung, forming a first row of electrical windings along a first direction; a second row of at least one rung, wherein an electrically conductive winding is wound around each rung of the at least one rung, forming a second row of electrical windings along the first direction; and a middle rail having a width along a second direction normal to the first direction, separating the first and the second row of electrical windings.

Disclosed embodiments may include a multiphase coupled inductor including a first coupled inductor and a second coupled inductor. In some embodiments, each of the first and the second coupled inductors may include: a magnetic ladder core including: a top rail extending along a first direction; a bottom rail parallel to the top rail and extending along the first direction; at least one rung between the top and the bottom rails, wherein adjacent rungs of the at least one rung are separated by a void; and an electrical winding around each rung of the at least one rung to form a row of electrical windings, wherein the first and the second coupled inductors are combined such that the bottom rail of the first coupled inductor merges with the top rail of the second coupled inductor to form a middle rail of the multiphase coupled inductor, and wherein the middle rail has a width along a second direction normal to the first direction.

Disclosed embodiments may include a multiphase coupled inductor including a plurality of coupled inductors, wherein each of the plurality of coupled inductors include: a magnetic ladder core including: a top rail extending along a first direction; a bottom rail parallel to the top rail and extending along the first direction; at least one rung between the top and the bottom rails, wherein adjacent rungs of the at least one rung are separated by a void; and an electrical winding around each rung of the at least one rung to form a row of electrical windings, wherein the plurality coupled inductors are combined to form the multiphase coupled inductor.

Disclosed embodiments may include a method of forming a multiphase coupled inductor, the method including: forming a magnetic ladder core assembly by: forming a first row of electrical windings along a first direction by winding an electrically conducting coil around each rung of a first row of at least one rung; and forming a second row of electrical windings along the first direction by winding an electrically conducting coil around each rung of a second row of at least one rung, wherein the first and the second row of electrical windings are separated by a middle rail having a width along a second direction normal to the first direction.

Disclosed embodiments may include a method of forming a multiphase coupled inductor, the method including: forming a first coupled inductor; and forming a second coupled inductor, wherein forming each of the first and the second coupled inductors include: forming a magnetic ladder core including: a top rail extending along a first direction; a bottom rail parallel to the top rail and extending along the first direction; at least one rungs between the top and the bottom rails, wherein adjacent rungs of the at least one rung are separated by a void; and winding an electrically conducting coil around each rung of the at least one rung to form a row of electrical windings; and combining the first and the second coupled inductors such that the bottom rail of the first coupled inductor merges with the top rail of the second coupled inductor to form a middle rail of the multiphase coupled inductor.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

### BRIEF DESCRIPTION OF THE DRAWINGS

Embodiments and various aspects of the present disclosure are illustrated in the following detailed description and the accompanying figures. It is noted that, in accordance with standard practice in the industry, various features are not drawn to scale. In fact, the dimensions of the various features may be arbitrarily increased or reduced for clarity of discussion.

FIG. 1A is a diagram illustrating an exemplary power converter employing a multiphase coupled inductor, in accordance with some embodiments of the present disclosure.

FIG. 1B is a graph illustrating an example operation of the exemplary power converter depicted in FIG. 1A, in accordance with some embodiments of the present disclosure.

FIG. 1C is a diagram illustrating exemplary coupled inductors, in accordance with some embodiments of the present disclosure.

FIG. 2 is a diagram illustrating an exemplary multiphase coupled inductor, in accordance with some embodiments of the present disclosure.

FIGS. 3A-3D are diagrams illustrating an exemplary coupled inductor, in accordance with some embodiments of the present disclosure.

FIGS. 4A-4C are diagrams illustrating an exemplary multiphase coupled inductor, in accordance with some embodiments of the present disclosure.

FIG. 5A illustrates an exemplary coupled inductor, in accordance with some embodiments of the present disclosure.

FIG. 5B illustrates a plot of simulated performance of an exemplary coupled inductor, in accordance with some embodiments of the present disclosure.

FIG. 6A illustrates an exemplary multiphase coupled inductor, in accordance with some embodiments of the present disclosure.

FIG. 6B illustrates a plot of simulated performance of an exemplary multiphase coupled inductor, in accordance with some embodiments of the present disclosure.

FIG. 7A illustrates an exemplary multiphase coupled inductor, in accordance with some embodiments of the present disclosure.

FIG. 7B illustrates a plot of simulated performance of an exemplary multiphase coupled inductor, in accordance with some embodiments of the present disclosure.

FIGS. 8A-8D illustrate an exemplary multiphase coupled inductor, in accordance with some embodiments of the present disclosure.

FIGS. 9A-9C are diagrams illustrating an exemplary multiphase coupled inductor, in accordance with some embodiments of the present disclosure.

FIGS. 10A and 10B are diagrams illustrating an exemplary coupled inductor, in accordance with some embodiments of the present disclosure.

FIGS. 11 and 12 are diagrams illustrating exemplary methods of forming a multiphase coupled inductor, in accordance with some embodiments of the present disclosure.

### DETAILED DESCRIPTION

The following disclosure provides many different exemplary embodiments, or examples, for implementing different features of the provided subject matter. Specific simplified examples of components and arrangements are described below to explain the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Throughout the figures, components may be referenced using a combination of alphanumeric characters, some of which may include subscripts. Within this specification, the subscripts may be formatted as plain characters. For example, “Vᵢₙ” from the figures may be referred to as “Vin” within the specification. As another example, “S_{1A}” from the figures may be referred to as “S1A” within the specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In this document, the term “coupled” may also be termed as “electrically coupled,” and the term “connected” may be termed as “electrically connected.” “Coupled” and “connected” may also be used to indicate that two or more elements cooperate or interact with each other.

Throughout this disclosure, embodiments are discussed in relation to particular electrical components, such as capacitors and inductors. Although an individual component may be discussed (e.g., a single capacitor, a single inductor), a combination of multiple components may be substituted for the single component. For example, while a single capacitor may be discussed or depicted, two or more capacitors (e.g., in series, parallel, or a combination of the two) may be substituted so long as the required qualities remain the same. In this example, an embodiment that calls for a single 20 mF capacitor may use two capacitors of 10 mF in parallel instead. Similar substitutions may be made for inductors.

Disclosed embodiments may include circuits and techniques to power converters and more particularly to power converters having a high voltage conversion ratio, requiring small output current ripple, and demanding fast-dynamic response. Disclosed embodiments may include a converter that is particularly suitable to power microprocessors in data centers, telecom base stations, and consumer electronics.

Disclosed embodiments may include a power conversion circuit and architecture that can achieve high efficiency and high voltage conversion ratio by mixing the operation of a switched capacitor charge distributor and a multiphase DC-DC voltage regulator. The circuits may include a magnetic structure and package, which may achieve high performance with a high voltage conversion ratio while offering low output current ripple and fast dynamic response. The converter can be used, for example, to supply electricity to low voltage high current microprocessors in data centers.

Switched-mode power converter may be used to step-down voltage. These types of converters may transfer energy from the converter input to output with the help of inductors or coupled inductors. Such magnetic-based topologies may include synchronous buck converters, interleaved synchronous buck converters, three-level buck converters, and many others. Designs of this type may efficiently provide a regulated output from a variable input voltage with high-bandwidth control of the output. However, such designs may not be suitable for applications with high input voltage. For example, because the switches of a buck converter can handle both high voltage stress and high current stress, it may not be a good design for handling high input voltage. Since the inductors may be used to block high voltages, the sizes of these inductors may need to be large. As another issue, increasing the operation frequency of switched-mode power converters can reduce the component size and increase the control bandwidth. The hard-switching operation of these converters may limit the efficiency and power density that can be achieved. They also may include packaging constraints. Also, inductors used in these designs may suffer from high AC flux, which may place challenges on efficiency, power density, and dynamic performance.

Disclosed embodiments may address these challenges by achieving AC flux cancellation, reduced power loss, and a reduced inductor core size.

In some embodiments, coupled inductors may include one or more of the following variations: mixed core materials, windings that form posts that extend orthogonal to the bottom of the core, a core that includes a cap layer that covers (in part or whole) the windings, a cap layer that includes a gap (e.g., to adjust or control leakage inductance), windings that tesselate, and/or windings that are adjacent without tessellating. Although not necessarily explicitly depicted in the figures, disclosed embodiments may include all combinations, sub-combinations, and permutations of these features. For example, disclosed embodiments may include a mixed core and a cap layer on top of the core (e.g., with or without a gap) and non-tessellating windings even though this particular combination of features is not explicitly shown together in a given figure.

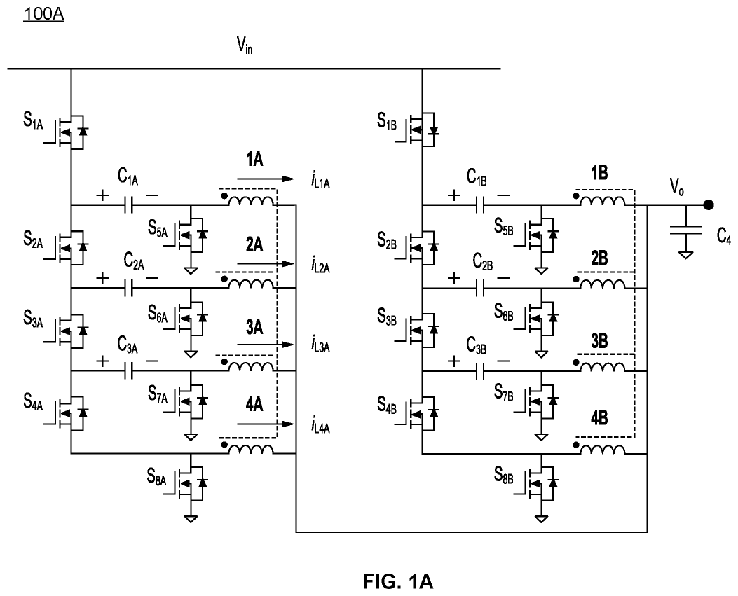

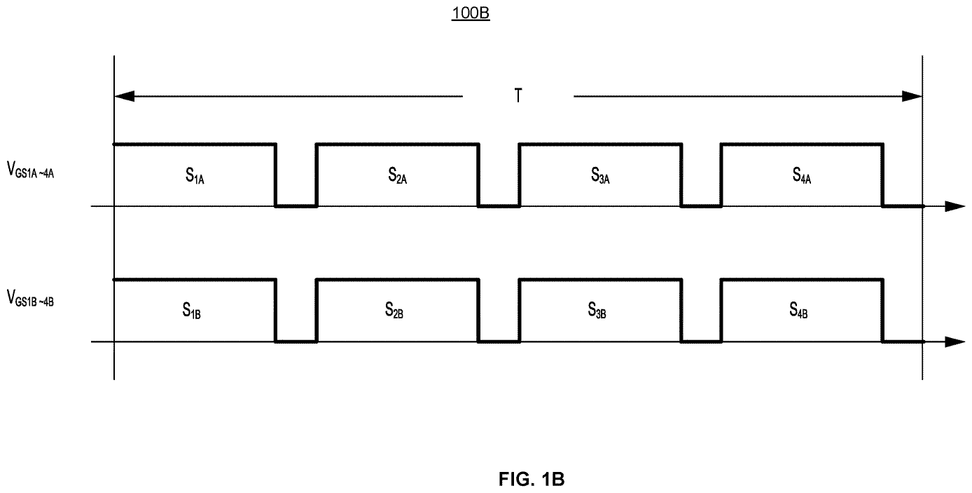

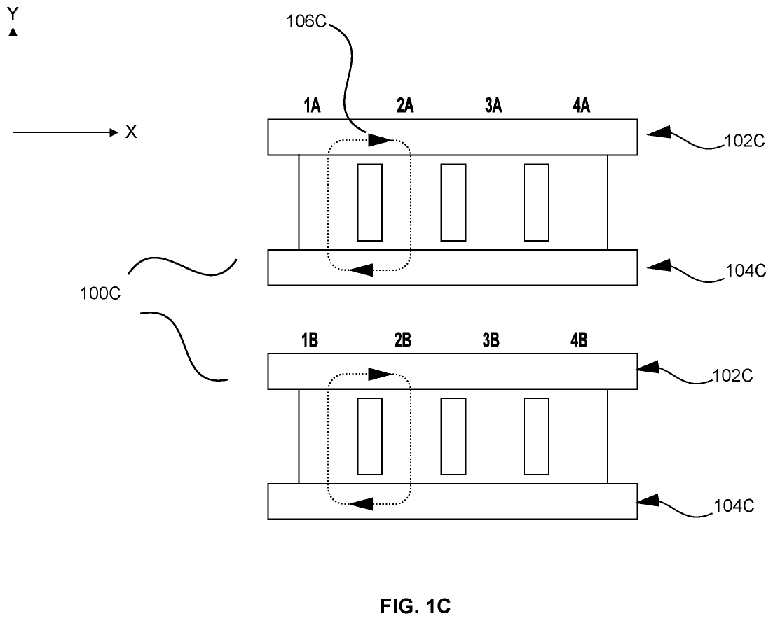

FIG. 1A is a diagram illustrating an exemplary employing a multiphase coupled inductor, in accordance with some embodiments of the present disclosure. In some embodiments, power converter 100A may include switches S1A through S8A and switches S1B through S8B, inductors 1A through 4A and inductors 1B through 4B, and capacitors C1A through C3A and capacitors C1B through C3B and capacitor C4, with nodes Vin and V0. In some embodiments, the switches may be implemented as MOSFETs, Gallium Nitride High Electron Mobility Transistors (GaN HEMTs) and/or other semiconductor switches. In some embodiments, power converter 100A may form a switched capacitor charge distributor that drives an eight-phase series-capacitor buck converter. The inductors of power converter 100A may be coupled. For example, the inductors may couple all eight buck phases with one magnetic core.

While power converter 100A shows eight buck phases coupled with one magnetic core, the disclosed embodiments may include any number of buck phases coupled to one magnetic core.

FIG. 1B is a graph 100B illustrating an example operation of the exemplary power converter depicted in FIG. 1A, in accordance with some embodiments of the present disclosure. The continuous time-dependent plots indicate when a switch is in an “on” or electrically conductive state and when it is in an “off” or open circuit state. For example, as depicted in graph 100B, all switches S1A, S2A, S3A, S4A, S1B, S2B, S3B, and S4B may operate at the same switching frequency and the corresponding winding voltages of inductors 1A-4A and 1B-4B are in phase.

FIG. 1C is a diagram illustrating exemplary coupled inductors, in accordance with some embodiments of the present disclosure. FIG. 1C provides a two-dimensional diagram of a first and a second coupled inductor 100C. In some embodiments, each coupled inductor 100C may be comprised of a magnetic ladder core. In some embodiments, a magnetic ladder core may be comprised of a top rail 102C extending along a first direction X, a bottom rail 104C parallel to the top rail 102C and extending along the first direction X, four rungs between the top rail 102C and the bottom rail 104C, wherein adjacent rungs of the four of rungs are separated by a void, and an electrical winding (not shown) around each rung of the four of rungs to form a row of electrical windings. Although FIG. 1C depicts two four-phase coupled inductors with four rungs between top rail 102C and bottom rail 104C, in general, there may be any number of rungs of at least one rung between the top rail and bottom rail.

In some existing systems, one coupled inductor 100C may couple four buck phases of inductors 1A-4A of FIG. 1A with one magnetic core while another coupled inductor 100C may couple four buck phases of inductors 1B-4B of FIG. 1A with another magnetic core. Arrows depicting exemplary AC flux 106C in each magnetic ladder core 100C is shown to be flowing in the same direction in phase.

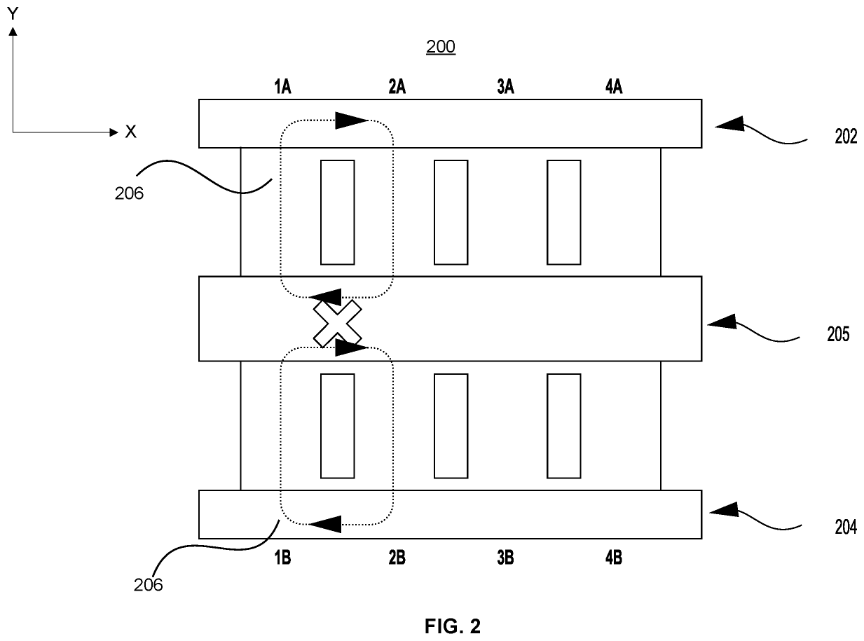

FIG. 2 is a diagram illustrating an exemplary multiphase coupled inductor, in accordance with some embodiments of the present disclosure. FIG. 2 provides a two-dimensional diagram of a multiphase coupled inductor 200. In some embodiments, a multiphase coupled inductor 200 may be comprised of a magnetic ladder core assembly. In some embodiments, a magnetic ladder core assembly may be comprised of a first row of at least one rung, wherein an electrically conductive winding (not shown) is wound around each rung of the at least one rung, forming a first row of electrical windings along a first direction X; a second row of at least one rung, wherein an electrically conductive winding (not shown) is wound around each rung of the at least one rung, forming a second row of electrical windings along the first direction X; a middle rail 205 having a width along a second direction Y normal to the first direction X, separating the first and the second row of electrical windings; a top rail 202 formed above the middle rail 205 such that the first row of electrical windings is located between the top rail 202 and the middle rail 205; and a bottom rail 204 formed below the middle rail 205 such that the second row of electrical windings is located between the middle rail 205 and the bottom rail 204. In some embodiments, the first row of electrical windings, the second row of electrical windings, and the middle rail 205 are coplanar.

Further, in other embodiments a multiphase coupled inductor 200 may be comprised of a first coupled inductor 100C and a second coupled inductor 100C, as described above, wherein the first coupled inductor 100C and the second coupled inductor 100C are combined such that the bottom rail 104C of the first coupled inductor merges with the top rail 102C of the second coupled inductor to form a middle rail 205 of the multiphase coupled inductor. In some embodiments, middle rail 205 may have a width along a second direction Y normal to the first direction X. As depicted, the first coupled inductor 100C and second coupled inductor 100C may each comprise a four-phase coupled inductor. Further, the first four-phase coupled inductor and second four-phase coupled inductor may be merged to form an eight-phase coupled inductor shown in FIG. 2. For example, multiphase coupled inductor 200 may couple eight buck phases of inductors 1A-4A and 1B-4B of FIG. 1A with one magnetic core.

In some embodiments, the top rail 202, middle rail 205, bottom rail 204, first row of the at least one rung, and the second row of the at least one rung may be made from similar magnetic materials. Further, in some embodiments at least two of the top rail 202, middle rail 205, bottom rail 204, first row of the at least one rung, and the second row of the at least one rung may be made from different or dissimilar magnetic materials.

In some embodiments, a coupling coefficient between windings within a row of electrical windings is higher than a coupling coefficient between the first and the second rows of electrical windings. Further, in some embodiments, a coupling coefficient between adjacent windings in the first direction X may be higher than a coupling coefficient between corresponding adjacent windings in the second direction Y. In some embodiments, exemplary AC flux 206 depicted is shown to be flowing the same direction in phase such that its effects are cancelled in the middle rail 205, advantageously increasing efficiency, power density, and dynamic performance as compared to using two separate coupled inductor 100Cs as shown in FIG. 1C.

In some embodiments, a multiphase coupled inductor 200 may be used in part or in whole in a power converter.

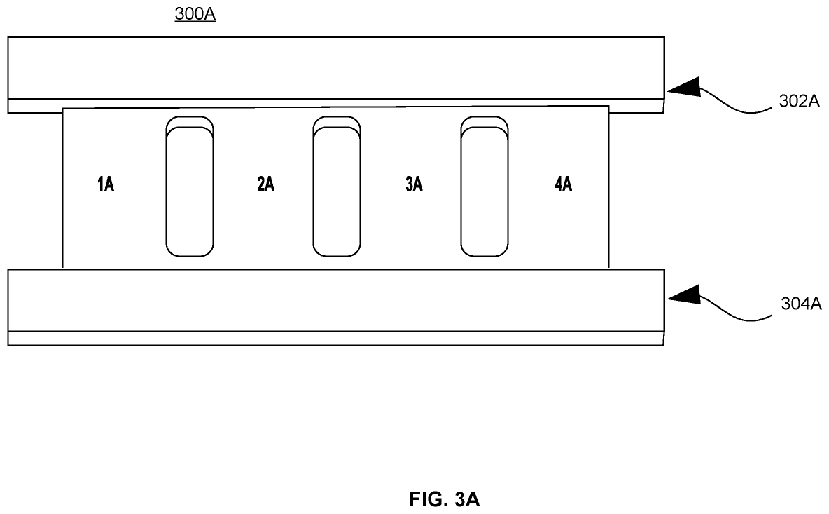

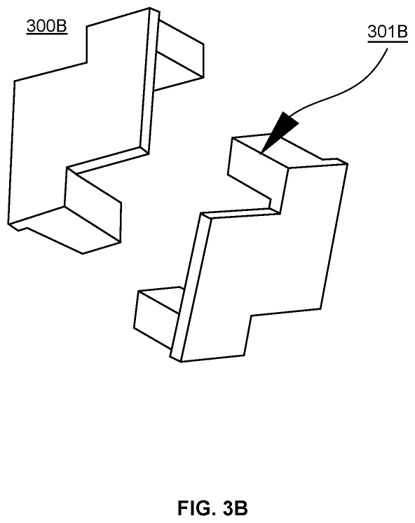

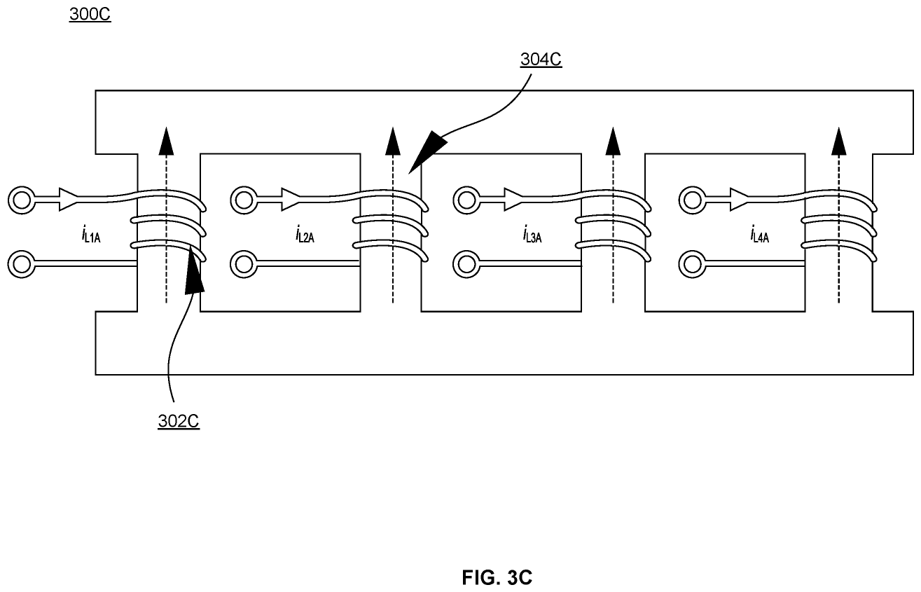

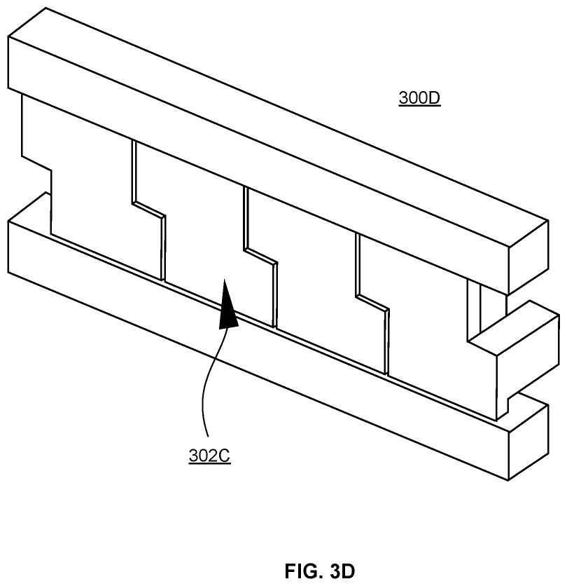

FIGS. 3A-3D are diagrams illustrating an exemplary coupled inductor (e.g., coupled inductor 100C of FIG. 1C), in accordance with some embodiments of the present disclosure.

FIG. 3A provides a diagram of a coupled inductor 300A. For example, in some embodiments, the rungs of the magnetic ladder core assembly may correspond to the inductors 1A, 2A, 3A, 4A used in a multiphase buck converter (e.g., power converter 100A of FIG. 1A).

FIG. 3B illustrates exemplary electrical windings 300B. In some embodiments, windings 300B may wrap the rungs of the magnetic ladder core of coupled inductor 300A. In some embodiments, windings 300B may be made from a magnetic material including, but not limited to, copper, aluminum, or other suitable materials. In some embodiments, windings 300B may involve legs 301B. Legs 301B may be configured to facilitate windings 300B wrapping of the rungs of the magnetic ladder core of a coupled inductor, such as coupled inductor 300A.

FIG. 3C illustrates a simplified structure of a coupled inductor 300C with electrical windings 302C wrapped around the rungs 304C. For example, the direction of the current (e.g., iL1A-iL4A) through each rung are depicted.

FIG. 3D is a diagram illustrating an exemplary coupled inductor 300D, in accordance with some embodiments of the present disclosure. For example, electrical windings 302D may be wrapped around the rungs of coupled inductor 300E to form a tessellating pattern.

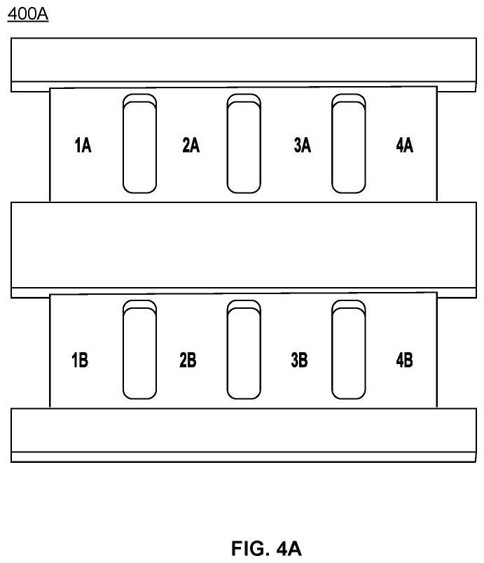

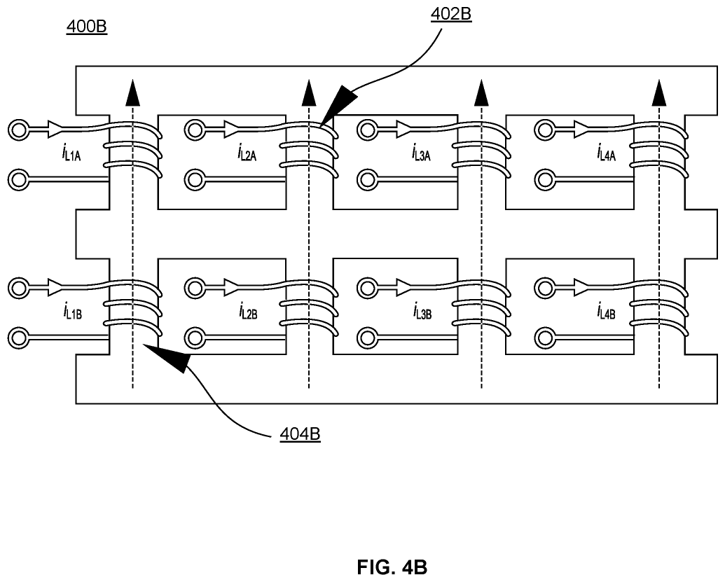

FIGS. 4A-4C are diagrams illustrating an exemplary multiphase coupled inductor, in accordance with some embodiments of the present disclosure.

FIG. 4A depicts a diagram of a magnetic ladder core assembly 400A. For example, in some embodiments, the rungs of the magnetic ladder core assembly 400A may correspond to the inductors 1A-4A and 1B-4B used in a multiphase buck converter (e.g., power converter 100A of FIG. 1A).

FIG. 4B illustrates a simplified structure of a multiphase coupled inductor 400B with windings 402B wrapped around the rungs 404B. For example, the direction of the current (e.g., iL1A-iL4A and iL1B-iL4B) through each rung are depicted. Further, as depicted, the inductors corresponding to the rungs 404B are in phase.

FIG. 4C is a diagram illustrating an exemplary multiphase coupled inductor 400C, in accordance with some embodiments of the present disclosure. For example, electrical windings 402C wrap around the rungs of multiphase coupled inductor 400C to form a tessellating pattern.

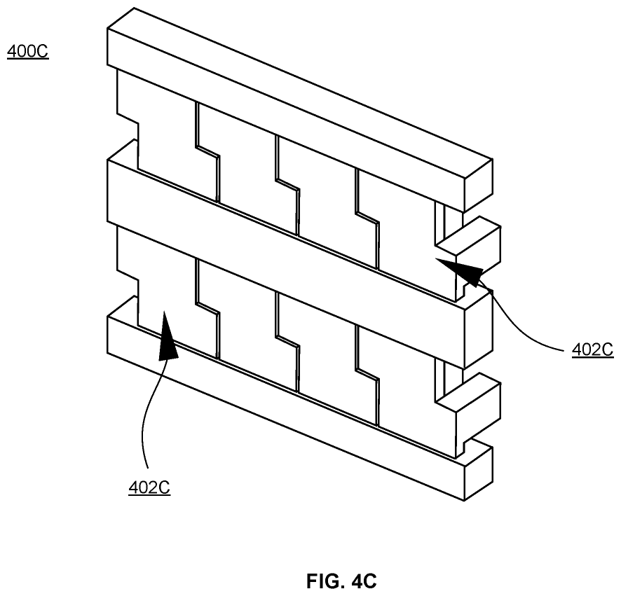

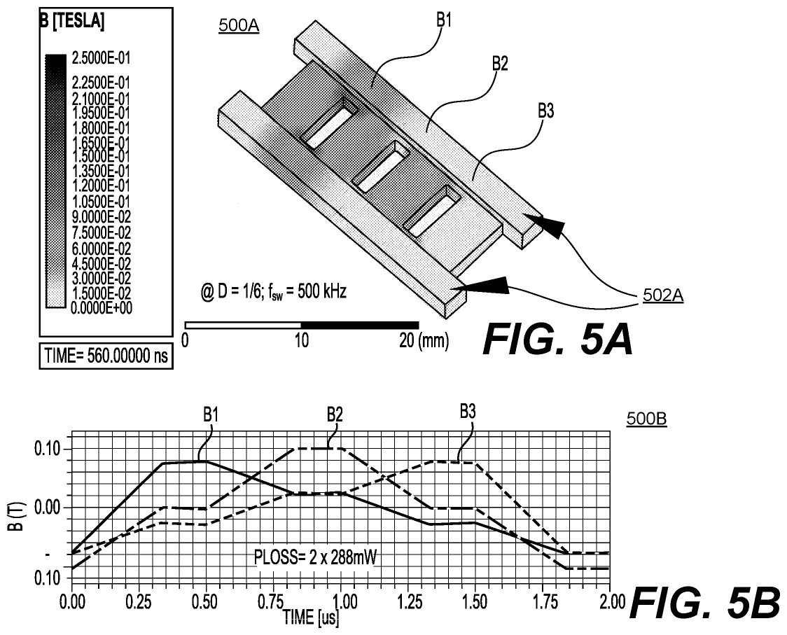

FIG. 5A illustrates an exemplary coupled inductor 500A, in accordance with some embodiments of the present disclosure. FIG. 5A depicts an example AC magnetic field transient simulation. The lighter shading depicted on coupled inductor 500A indicates an increase in AC magnetic flux density.

FIG. 5B illustrates a plot of simulated performance of an exemplary coupled inductor, in accordance with some embodiments of the present disclosure. FIG. 5B depicts an example graph 500B showing magnetic B-field strength (e.g., AC magnetic flux density) over time for the regions corresponding to B1, B2, and B3 of a header 502A of coupled inductor 500A. In this exemplary embodiment, the power loss is 2×288 mW.

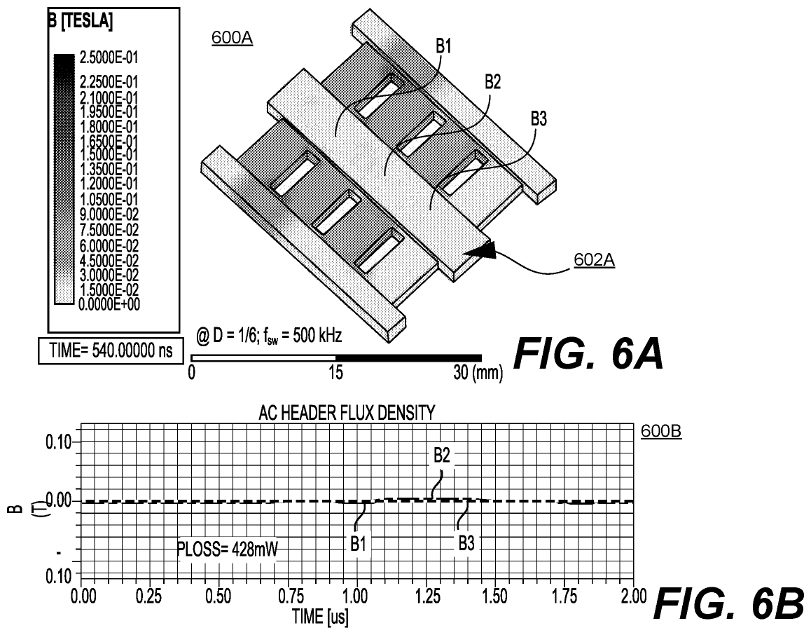

FIG. 6A illustrates an exemplary multiphase coupled inductor 600A, in accordance with some embodiments of the present disclosure. FIG. 6A depicts an example AC magnetic field transient simulation for a multiphase coupled inductor. In some embodiments, the middle rail 602A may have a width that may be equal to double the width of either the top rail or bottom rail. The lighter shading indicates an increase in AC magnetic flux density. As shown in FIG. 6A, the AC magnetic flux density in the middle rail is substantially equal to zero.

FIG. 6B illustrates a plot of simulated performance of exemplary multiphase coupled inductor 600A, in accordance with some embodiments of the present disclosure. FIG. 6B depicts an example graph 600B showing magnetic B-field strength (e.g., AC magnetic flux density) over time for the regions corresponding to B1, B2, and B3 of the middle rail 602A of multiphase coupled inductor 600A. For example, the AC flux density of the middle rail 602A is depicted as near zero and unchanging over time due to the middle rail's cancellation of AC flux in that region. In this exemplary embodiment, the power loss is 428 mW.

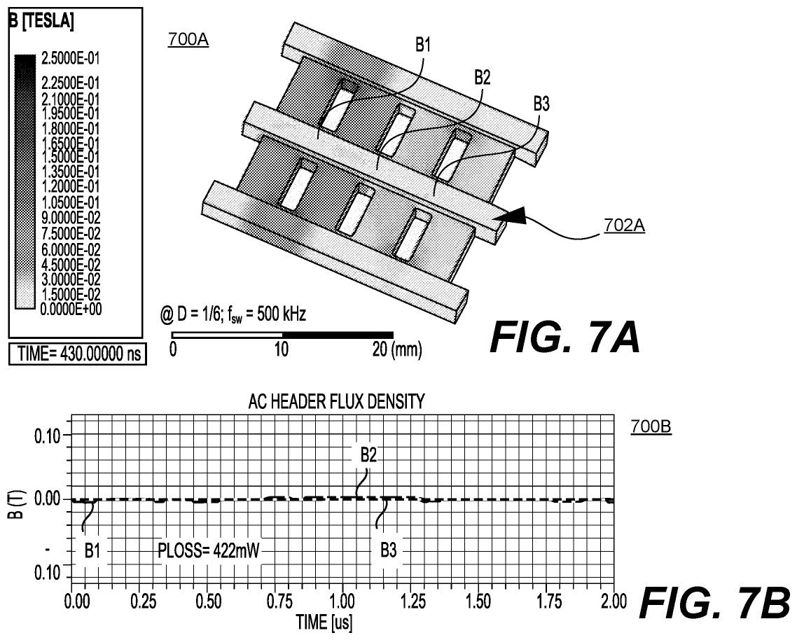

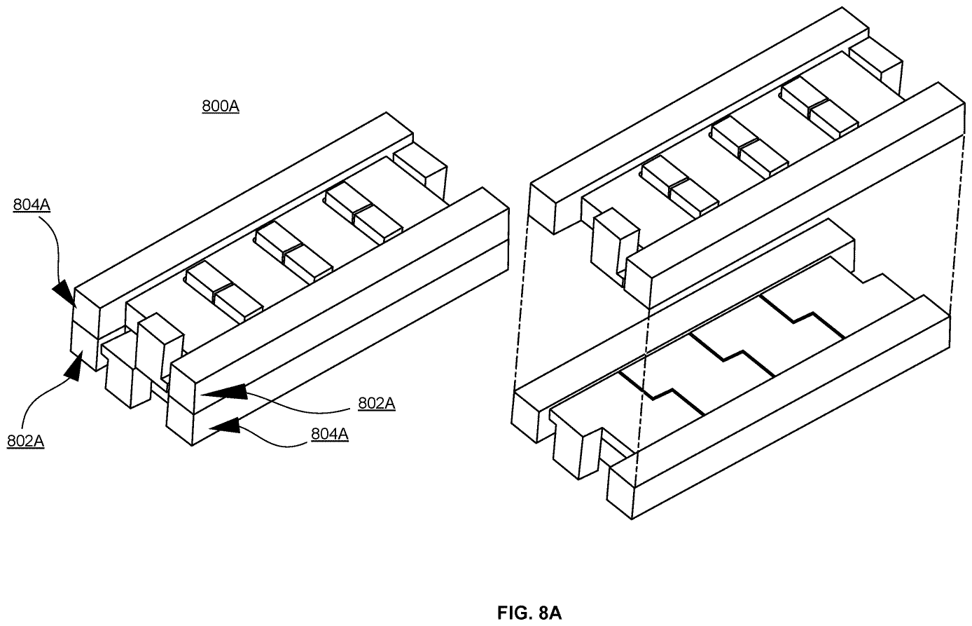

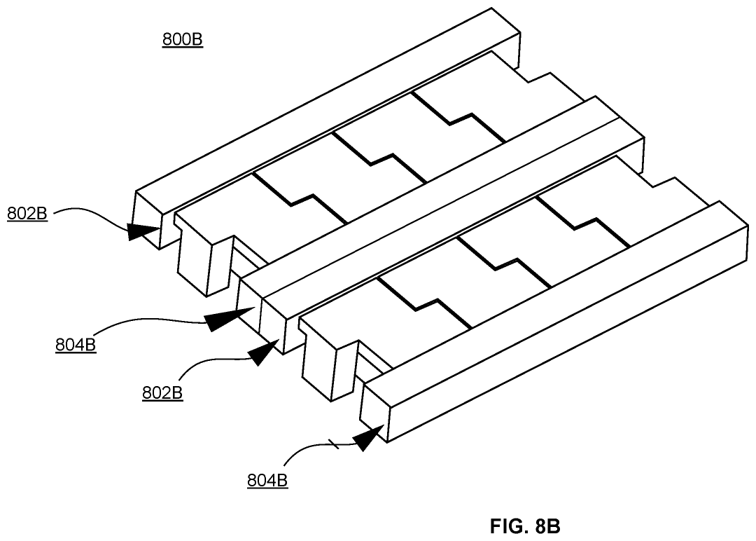

FIG. 7A illustrates an exemplary multiphase coupled inductor 700A, in accordance with some embodiments of the present disclosure. FIG. 7A depicts an example AC magnetic field transient simulation for a multiphase coupled inductor with a middle rail 702A having a width equal to the width of the top rail and bottom rail. The lighter shading indicates an increase in AC magnetic flux density. As shown in FIG. 7A, the AC magnetic flux density in the middle rail 702A is substantially equal to zero.

FIG. 7B illustrates a plot of simulated performance of exemplary multiphase coupled inductor 700A, in accordance with some embodiments of the present disclosure. FIG. 7B depicts an example graph 700B showing magnetic B-field strength (e.g., AC magnetic flux density) over time for the regions corresponding to B1, B2, and B3 of the middle rail 702A of multiphase coupled inductor 700B. In this exemplary embodiment, the power loss is 422 mW.

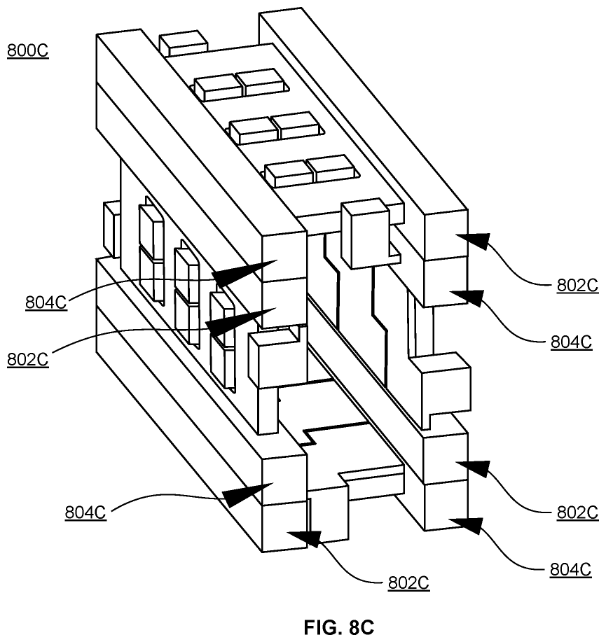

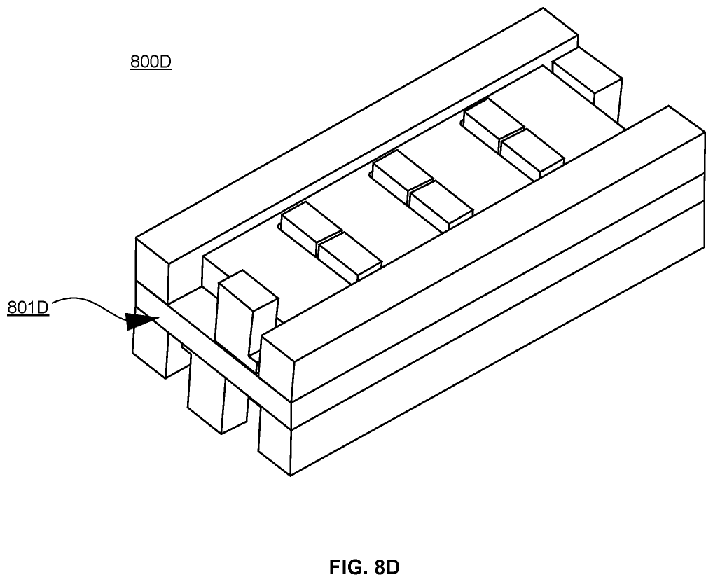

FIGS. 8A, 8B, 8C, and 8D illustrate exemplary multiphase coupled inductors, in accordance with some embodiments of the present disclosure. Disclosed embodiments may include different configurations, orientations, and/or number of magnetic ladder cores to form a magnetic ladder core assembly with rail(s) that result in mitigated (e.g., cancelled or substantially zero) AC flux. Each of the exemplary multiphase coupled inductors depicted in FIGS. 8A, 8B, 8C, and 8D may involve a plurality of coupled inductors that are combined to form the exemplary multiphase coupled inductor. In some embodiments, a face of a coupled inductor, as used herein, may refer to the side of a coupled inductor that does not expose the legs 301B of the electrical windings 300B. In some embodiments, a face of a coupled inductor, as used herein, may refer to the side of a coupled inductor that does expose the legs 301B of the electrical windings 300B.

FIG. 8A illustrates an exemplary multiphase coupled inductor 800A that may be constructed by placing one coupled inductor on top of the other such that the top rail 802A of the bottom magnetic ladder core is in parallel and aligned with the bottom rail 804A of the top magnetic ladder core such that one coupled inductor is spaced apart from the other coupled inductor in a second direction normal to the first direction. In some embodiments, the face of one coupled inductor is coupled with the face of the other coupled inductor.

FIG. 8B illustrates an exemplary multiphase coupled inductor 800B that may be constructed by connecting the bottom rail 804B of one coupled inductor with the top rail 802A of another coupled inductor such that one coupled inductor is coplanar with the other coupled inductor. In some embodiments, the face of one coupled inductor and the face of the other coupled inductor do not overlap.

FIG. 8C illustrates an exemplary multiphase coupled inductor 800C that may be constructed by attaching the bottom rail 804C of a coupled inductor orthogonally to the top rail 802C of another coupled inductor such that four coupled inductors form a three-dimensional rectangular multiphase coupled inductor 800C. For example, the top rail 802C of a first coupled inductor may be coupled with the bottom rail 804C of a second coupled inductor, the top rail 802C of the second coupled inductor may be coupled with the bottom rail 804C of a third coupled inductor, the top rail 802C of the third coupled inductor may be coupled with the bottom rail 804C of a fourth coupled inductor, and the top rail 802C of the fourth coupled inductor may be coupled with the bottom rail 804C of the first coupled inductor. Further, the face of the first coupled inductor may be parallel to the face of the third coupled inductor, the face of the second coupled inductor may be parallel to the face of the fourth coupled inductor, and the faces of the first and third coupled inductors may be perpendicular to the faces of the second and fourth coupled inductors.

FIG. 8D illustrates an exemplary multiphase coupled inductor 800D that may be constructed similarly to that of FIG. 8A and with a cap layer 801D between the top coupled inductor and the bottom coupled inductor such that the cap layer 801D is coupled with the top coupled inductor and the bottom coupled inductor. The cap layer may include a gap, which may be configured to adjust or control leakage inductance. Further, the cap layer 801D may be positioned or located between the face of the top coupled inductor and the face of the bottom coupled inductor.

Although example configurations depicted in FIGS. 8A, 8B, 8C, and 8D are used, other configurations may also be used that may comprise of a plurality of coupled inductors in a two-dimensional grid pattern. Although not explicitly enumerated, still other variations on a multiphase coupled inductor may be formed such that the AC flux of connected rails is cancelled out.

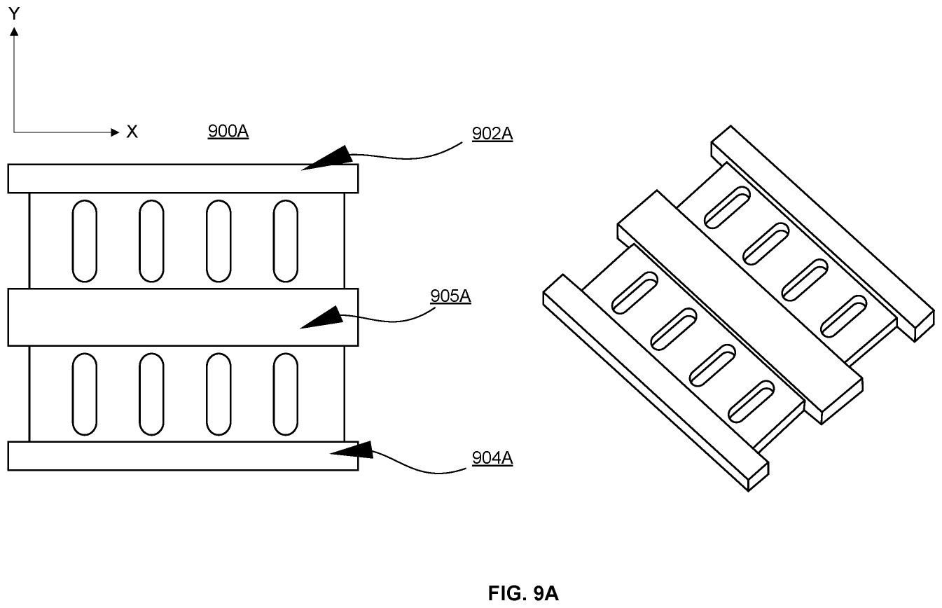

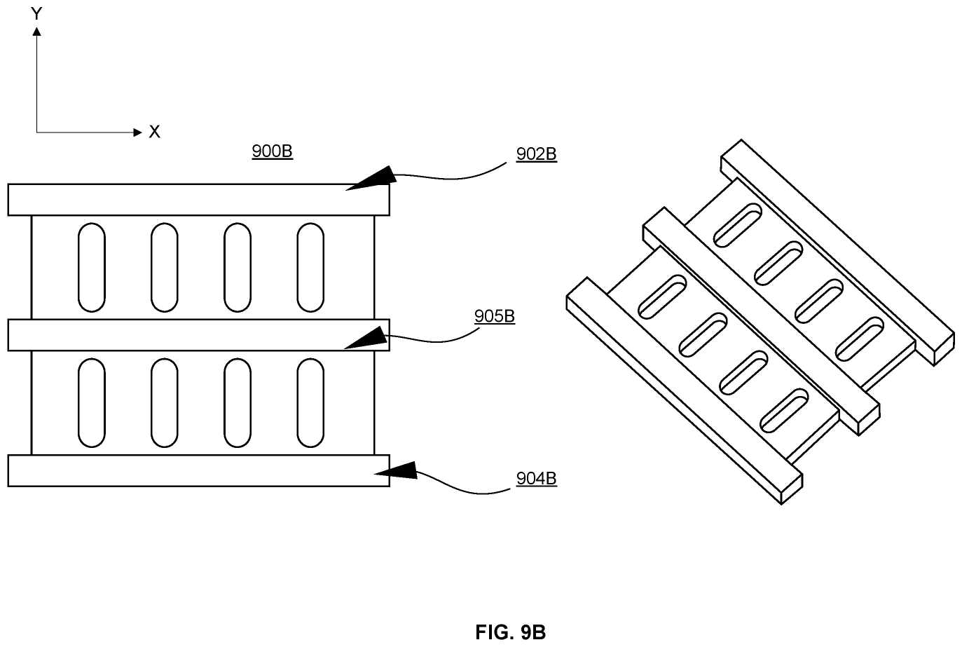

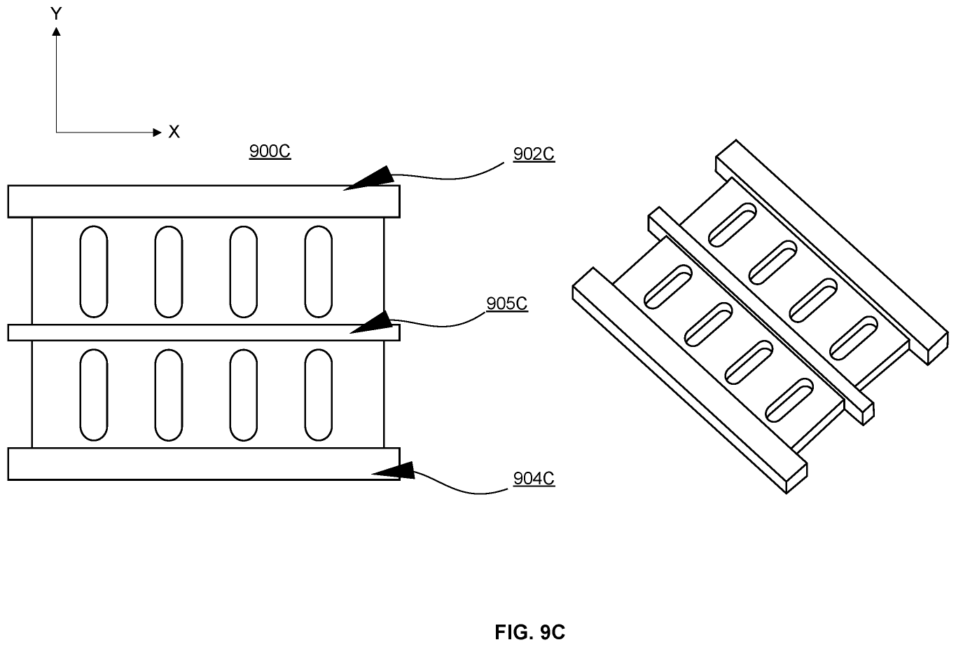

FIGS. 9A-9C are diagrams illustrating an exemplary multiphase coupled inductor, in accordance with some embodiments of the present disclosure.

FIG. 9A depict an exemplary multiphase coupled inductor 900A. As depicted, the width of the middle rail 905A is greater than the width of either the top rail 902A or the bottom rail 904A.

FIG. 9B depict an exemplary multiphase coupled inductor 900B. As depicted, the width of the middle rail 905B is substantially equal to the width of either the top rail 902B or the bottom rail 904B.

FIG. 9C depict an exemplary multiphase coupled inductor 900C. As depicted the width of the middle rail 905C is less than the width of either the top rail 902C or the bottom rail 904C.

The width of the middle rail is defined to be along a second direction Y normal to the first direction X. In some embodiments, the width of the middle rail of a magnetic ladder core assembly may be less than, equal to, or greater than the width of either the top rail or bottom rail. The width of the middle rail of a magnetic ladder core assembly may be adjusted to allow for a corresponding adjustment of leakage inductance of the multiphase coupled inductor. Further, the width of the middle rail of a magnetic ladder core assembly may also be adjusted to allow for a corresponding adjustment of AC flux density within the middle rail of the multiphase coupled inductor.

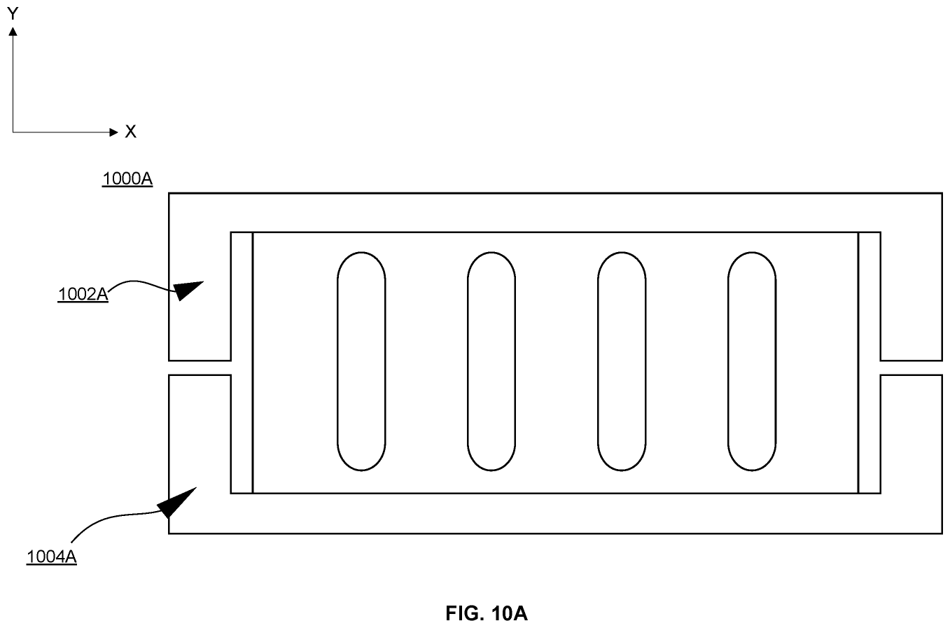

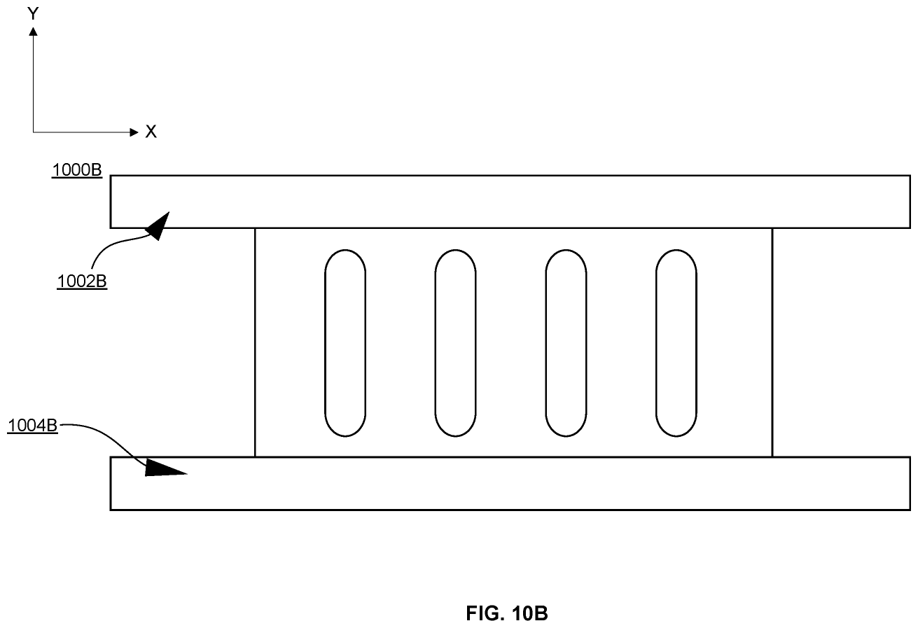

FIGS. 10A and 10B are diagrams illustrating an exemplary coupled inductor, in accordance with some embodiments of the present disclosure. In some embodiments, the ends of the top rail and the bottom rail may be lengthened or shortened to adjust the leakage inductance. Further, the ends of the top rail and the bottom rail may be oriented to bend towards each other such that they are almost connected. In some embodiments, the top rail and the bottom rail may not be shorted together.

For example, as depicted in FIG. 10A, the ends of the top rail 1002A and bottom rail 1004A of exemplary multiphase inductor 1000A are lengthened such that they have a bend in a second direction Y normal to the first direction X but are spaced apart from each other and/or not shorted together. In this way, the top rail 1002A and the bottom rial 1004A each comprise a portion extending in a second direction normal to the first direction, with the portion of the top rail and the portion of the bottom rail extending towards each other.

Further, as depicted in FIG. 10B, the ends of the top rail 1002B and bottom rail 1004B of exemplary multiphase inductor 1000B may be lengthened along the first direction X.

Although exemplary embodiments depicted in FIGS. 10A and 10B are coupled inductors, it is to be understood that the same manipulation of the lengths of the top rail and bottom rail can be similarly applied to the top rail and bottom rail of multiphase coupled inductors.

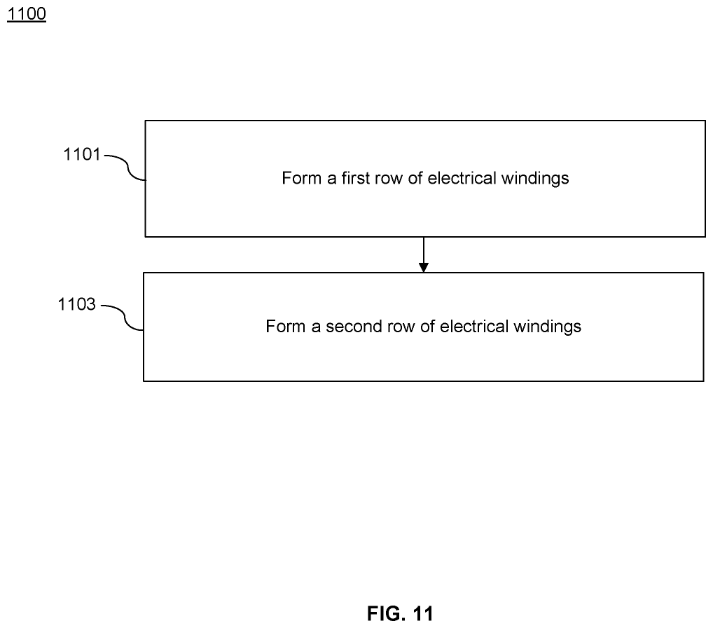

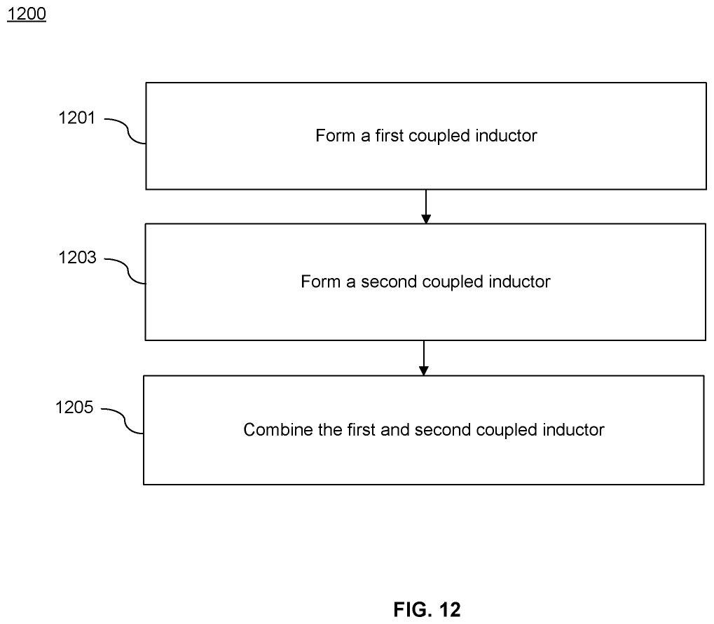

FIGS. 11 and 12 are diagrams illustrating exemplary methods of forming a multiphase coupled inductor, in accordance with some embodiments of the present disclosure.

For example, as depicted in FIG. 11, a multiphase coupled inductor may be formed by process 1100. In step 1101, a magnetic ladder core assembly may include by forming a first row of electrical windings along a direction by winding an electrically conducting coil around each rung of a first row of at least one rung.

In step 1103, process 1100 may include forming a second row of electrical windings along the first direction by winding an electrically conducting coil around each rung of a second row of at least one rung,

In some embodiments, the first and the second row of electrical windings are separated by a middle rail having a width along a second direction normal to the first direction.

In some embodiments, as depicted in FIG. 12, a multiphase coupled inductor may be formed by process 1200. In step 1201, process 1200 may include forming a first coupled inductor by forming a magnetic ladder core comprising a top rail extending along a first direction; a bottom rail parallel to the top rail and extending along the first direction; at least one rung between the top rail and the bottom rail, wherein adjacent rungs of the at least one rung are separated by a void; and winding an electrically conducting coil around each rung of the at least one rung to form a row of electrical windings.

In step 1203, process 1200 may include forming a second coupled inductor in a similar manner to forming a first coupled inductor in step 1201.

In step 1205, process 1200 may include combining the first and the second coupled inductors such that the bottom rail of the first coupled inductor merges with the top rail of the second coupled inductor to form a middle rail of the multiphase coupled inductor.

Further, process 1100 and process 1200 are not necessarily limited to the steps shown in FIG. 11 and FIG. 12, respectively, and any steps or processes of the various embodiments described throughout the present disclosure may also be included in either process 1100 or process 1200.

Disclosed embodiments may include switched-capacitor power converters. Switched-capacitors may also be referred to as cascade multipliers, switching capacitors, switched capacitors, switch capacitors, charge pumps, and voltage multipliers. The advantages and benefits of switched-capacitor power converters may enable them to be used in a wide array of applications. For example, applications of switched power converters include portable device, mobile computing, and/or communication products and components (e.g., notebook computers, ultra-book computers, tablet devices, and cell phones), displays (e.g., LCDs, LEDs), radio-based devices and systems (e.g., cellular systems, WiFi, Bluetooth, Zigbee, Z-Wave, and GPS-based devices), wired network devices and systems, data centers (e.g., for battery-backup systems and/or power conversion for processing systems and/or electronic/optical networking systems), internet-of-things (IOT) devices (e.g., smart switches and lights, safety sensors, and security cameras), household appliances and electronics (e.g., set-top boxes, battery-operated vacuum cleaners, appliances with built-in radio transceivers such as washers, dryers, and refrigerators), AC/DC power converters, use in electric vehicles of all types (e.g., for drive trains, control systems, and/or infotainment systems), and other devices and systems that utilize portable electricity generating sources and/or require power conversion.

Disclosed embodiments may include switched-capacitor power converters that utilize specific types of capacitors, particularly for the fly capacitors. For example, it may be useful for fly capacitors to have low equivalent series resistance (ESR), low DC bias degradation, high capacitance, and/or small volume. Low ESR may be of particular importance for switched-capacitor power converters that incorporate additional switches and fly capacitors to increase the number of voltage levels. Disclosed embodiments may include a particular capacitor based on a consideration of specifications for power level, efficiency, size, etc. Various types of capacitor technologies may be used, including ceramic (including multi-layer ceramic capacitors (MLCC)), electrolytic capacitors, film capacitors (including power film capacitors), and IC-based capacitors. Capacitor dielectrics may vary as needed for particular applications, and may include dielectrics that are paraelectric, such as silicon dioxide (SiO2), hafnium dioxide (HFO2), or aluminum oxide Al₂O₃. In addition, switched-capacitor power converter designs may beneficially utilize intrinsic parasitic capacitances (e.g., intrinsic to the power FETs) in conjunction with or in lieu of designed capacitors to reduce circuit size and/or increase circuit performance. Disclosed embodiments may also select capacitors for switched capacitor converters based on capacitor component variations, reduced effective capacitance with DC bias, and ceramic capacitor temperature coefficients (e.g., minimum and maximum temperature operating limits, and capacitance variation with temperature).

Similarly, in various embodiments of switched-capacitor power converters, it may be beneficial to use specific types of inductors. For example, disclosed embodiments may include inductors that have low DC equivalent resistance, high inductance, and small volume to increase performance.

Disclosed embodiments may include one or more controllers to control, for example, the startup and operation of disclosed embodiments. Controller(s) may be implemented as a microprocessor, a microcontroller, a digital signal processor (DSP), register-transfer level (RTL) circuitry, and/or combinatorial logic.

Disclosed embodiments may include one or more MOSFETs. In embodiments, a MOSFET may refer to any field effect transistor (FET) having an insulated gate whose voltage determines the conductivity of the transistor. In some embodiments, MOSFETS may encompass insulated gates having a metal or metal-like, insulator, and/or semiconductor structure. The metal or metal-like structures may include at least one electrically conductive material (such as aluminum, copper, or other metal, or highly doped polysilicon, graphene, or other electrical conductors). The insulator structures may include at least one insulating material (such as silicon oxide or other dielectric material). The semiconductor structures may include at least one semiconductor material.

Disclosed embodiments can meet a wide variety of specifications and may be implemented in any suitable integrated circuit (IC) technology (including but not limited to MOSFET structures), or in hybrid or discrete circuit forms. Integrated circuit embodiments may be fabricated using any suitable substrates and processes, including but not limited to standard bulk silicon, high-resistivity bulk CMOS, silicon-on-insulator (SOI), and silicon-on-sapphire (SOS). Unless otherwise noted above, embodiments of the invention may be implemented in other transistor technologies such as bipolar, BiCMOS, LDMOS, BCD, GaAs HBT, GaN HEMT, GaAs pHEMT, and MESFET technologies. Fabrication in CMOS using SOI or SOS processes may enable circuits with low power consumption, the ability to withstand high power signals during operation due to FET stacking, good linearity, and high frequency operation (e.g., radio frequencies up to and exceeding 300 GHz). Monolithic IC implementation may be useful since parasitic capacitances generally can be kept low (or at a minimum, kept uniform across all units, permitting them to be compensated) by careful design.

Voltage levels may be adjusted, and/or voltage and/or logic signal polarities reversed, depending on a particular specification and/or implementing technology (e.g., NMOS, PMOS, or CMOS, and enhancement mode or depletion mode transistor devices). Disclosed embodiments may adjust component voltage, current, and power handling capabilities as needed, for example, by adjusting device sizes, serially “stacking” components (particularly FETs) to withstand greater voltages, and/or using multiple components in parallel to handle greater currents. Additional circuit components may be added to enhance the capabilities of the disclosed circuits and/or to provide additional functionality without significantly altering the functionality of the disclosed circuits.

Circuits and devices in accordance with the present disclosure may be used alone or in combination with other components, circuits, and devices. Embodiments may be fabricated as integrated circuits (ICs), which may be encased in IC packages and/or in modules for ease of handling, manufacture, and/or improved performance. For example, IC embodiments of the present disclosure may be used in modules in which one or more of such ICs are combined with other circuit components or blocks (e.g., filters, amplifiers, passive components, and possibly additional ICs) into one package. The ICs and/or modules may be then combined with other components, such as on a printed circuit board, to form part of an end product such as a cellular telephone, laptop computer, or electronic tablet, or to form a higher-level module which may be used in a wide variety of products, such as vehicles, test equipment, medical devices, etc. Through various configurations of modules and assemblies, such ICs may enable a mode of communication, such as wireless communication.

Embodiments may include implementations in hardware or software, or a combination of both (e.g., programmable logic arrays). In some embodiments, various general purpose computing machines may be used with programs written in accordance with the teachings herein. In other embodiments, a special purpose computer or special-purpose hardware (such as integrated circuits) may be used to perform particular functions. Embodiments may be implemented in one or more computer programs (i.e., a set of instructions or codes) executing on one or more programmed or programmable computer systems (which may be of various architectures, such as distributed, client/server, or grid) each including, for example, at least one processor, at least one data storage system (which may include volatile and non-volatile memory and/or storage elements), at least one input device or port, and/or at least one output device or port. Program instructions or code may be applied to input data to perform the functions described herein and generate output information. The output information may be applied to one or more output devices.

Disclosed embodiments may involve computer programs implemented in a computer language (e.g., machine, assembly, or high-level procedural, logical, object-oriented programming languages or a custom language/script) to communicate with a computer system and may be implemented in a distributed manner in which different parts of the computation specified by the software are performed by different processors. The computer language may be a compiled or interpreted language. Computer programs implementing certain embodiments may form one or more modules of a larger program or system of programs. Some or all of the elements of the computer program may be implemented as data structures stored in a computer readable medium or other organized data conforming to a data model stored in a data repository.

Disclosed embodiments may include computer program(s) that may be stored on or downloaded to (for example, by being encoded in a propagated signal and delivered over a communication medium such as a network) a tangible, non-transitory storage media or device (e.g., solid state memory media or devices, or magnetic or optical media) for a period of time (e.g., the time between refresh periods of a dynamic memory device, such as a dynamic RAM, or semi-permanently, or permanently), the storage media or device being readable by a general or special purpose programmable computer for configuring and operating the computer when the storage media or device is read by the computer system to perform the procedures described above. Disclosed embodiments may also be implemented as a non-transitory computer-readable storage medium, configured with a computer program, where the storage medium so configured causes a computer system to operate in a specific or predefined manner to perform the functions described above.

In the specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is also intended that the sequence of steps shown in figures is only for illustrative purposes and is not intended to be limited to any particular sequence of steps. As such, those skilled in the art can appreciate that these steps can be performed in a different order while implementing the same method.

It is appreciated that certain features of the specification, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not to be considered essential features of those embodiments unless the embodiment is inoperative without those elements.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Additional aspects of the present disclosure may be further described via the following clauses:
1. A multiphase coupled inductor, comprising:
   a magnetic ladder core assembly, comprising:
      a first row of at least one rung, wherein an electrically conductive winding is wound around each rung of the at least one rung, forming a first row of electrical windings along a first direction;
      a second row of at least one rung, wherein an electrically conductive winding is wound around each rung of the at least one rung, forming a second row of electrical windings along the first direction; and
      a middle rail having a width along a second direction normal to the first direction, separating the first and the second row of electrical windings.
2. The multiphase coupled inductor of clause 1, wherein the magnetic ladder core assembly further comprises a top rail formed above the middle rail such that the first row of electrical windings is located between the top rail and the middle rail.
3. The multiphase coupled inductor of clause 2, wherein the magnetic ladder core assembly further comprises a bottom rail formed below the middle rail such that the second row of electrical windings is located between the middle rail and the bottom rail.
4. The multiphase coupled inductor of clause 1, wherein a coupling coefficient between windings within a row of electrical windings is higher than a coupling coefficient between the first and the second rows of electrical windings.
5. The multiphase coupled inductor of clause 1, wherein a coupling coefficient between adjacent windings in the first direction is higher than a coupling coefficient between corresponding adjacent windings in the second direction.
6. The multiphase coupled inductor of clause 1, further comprising a plurality of magnetic ladder core assemblies forming a two-dimensional grid pattern.
7. The multiphase coupled inductor of clause 1, wherein the windings in the first and the second rows of the electrical windings form a tessellating pattern.
8. The multiphase coupled inductor of clause 1, wherein an adjustment of the width of the middle rail allows an adjustment of a leakage inductance of the multiphase coupled inductor.
9. The multiphase coupled inductor of clause 8, wherein the magnetic ladder core assembly further comprises a cap layer.
10. The multiphase coupled inductor of clause 9, wherein the cap layer is configured to further adjust the leakage inductance of the multiphase coupled inductor.
11. The multiphase coupled inductor of clause 1, wherein an adjustment of the width of the middle rail allows an adjustment of an alternating current (AC) flux density within the middle rail.
12. The multiphase coupled inductor of clause 1, wherein the first and the second rows of electrical windings and the middle rail are coplanar.
13. The multiphase coupled inductor of clause 3, wherein the top rail, the middle rail, the bottom rail, the first row of the at least one rung, and the second row of the at least one rung are made from similar magnetic materials.
14. The multiphase coupled inductor of clause 3, wherein at least two of the top rail, the middle rail, the bottom rail, the first row of the at least one rung, and the second row of the at least one rung are made from dissimilar magnetic materials.
15. A power converter comprising the multiphase coupled inductor of clause 1.
16. A multiphase coupled inductor, comprising:
   a first coupled inductor; and
   a second coupled inductor, wherein each of the first and the second coupled inductors comprise:
      a magnetic ladder core comprising:
         a top rail extending along a first direction;
         a bottom rail parallel to the top rail and extending along the first direction;
         at least one rung between the top and the bottom rails, wherein adjacent rungs of the at least one rung are separated by a void; and
         an electrical winding around each rung of the at least one rung to form a row of electrical windings,
   wherein the first and the second coupled inductors are combined such that the bottom rail of the first coupled inductor merges with the top rail of the second coupled inductor to form a middle rail of the multiphase coupled inductor, and
   wherein the middle rail has a width along a second direction normal to the first direction.
17. The multiphase coupled inductor of clause 16, wherein the first and the second coupled inductors comprise a four-phase coupled inductor.
18. The multiphase coupled inductor of clause 16, wherein the first and the second coupled inductors are merged to form an eight-phase coupled inductor.
19. The multiphase coupled inductor of clause 16, comprising a plurality of four-phase coupled inductors arranged in a two-dimensional grid pattern.
20. The multiphase coupled inductor of clause 19, wherein the plurality of four-phase coupled inductors is coplanar.
21. The multiphase coupled inductor of clause 16, wherein the middle rail of the multiphase coupled inductor has a width along a second direction normal to the first direction.
22. The multiphase coupled inductor of clause 21, wherein an adjustment of the width of the middle rail allows an adjustment of a leakage inductance of the multiphase coupled inductor.
23. The multiphase coupled inductor of clause 22, wherein the magnetic ladder core comprises a cap layer.
24. The multiphase coupled inductor of clause 23, wherein the cap layer is configured to further adjust the leakage inductance of the multiphase coupled inductor.
25. The multiphase coupled inductor of clause 16, wherein an adjustment of the width of the middle rail allows an adjustment of alternating current (AC) flux density within the middle rail.
26. A power converter comprising the multiphase coupled inductor of clause 16.
27. A multiphase coupled inductor, comprising:
   a plurality of coupled inductors, wherein each of the plurality of coupled inductors comprise:
      a magnetic ladder core comprising:
         a top rail extending along a first direction;
         a bottom rail parallel to the top rail and extending along the first direction;
         at least one rung between the top and the bottom rails, wherein adjacent rungs of the at least one rung are separated by a void; and
         an electrical winding around each rung of the at least one rung to form a row of electrical windings,
   wherein the plurality coupled inductors are combined to form the multiphase coupled inductor.
28. The multiphase coupled inductor of clause 27, wherein:
   the bottom rail of a first coupled inductor of the plurality of coupled inductors is coupled with the top rail of a second coupled inductor of the plurality of coupled inductors;
   the top rail of the first coupled inductor is coupled with the bottom rail of the second coupled inductor; and
   the first coupled inductor is spaced apart from the second coupled inductor in a second direction normal to the first direction.
29. The multiphase coupled inductor of clause 27, wherein:
   a face of a first coupled inductor of the plurality of coupled inductors is coupled with a face of a second coupled inductor of the plurality of coupled inductors.
30. The multiphase coupled inductor of clause 27, wherein:
   the bottom rail of a first coupled inductor of the plurality of coupled inductors is coupled with the top rail of a second coupled inductor of the plurality of coupled inductors; and
   the first coupled inductor and second coupled inductor are coplanar.
31. The multiphase coupled inductor of clause 27, wherein:
   a first coupled inductor of the plurality of coupled inductors is coupled with, and coplanar to, a second coupled inductor of the plurality of coupled inductors,
   wherein a face of the first coupled inductor and a face of the second coupled inductor do not overlap.
32. The magnetic coupled inductor of clause 27, wherein:
   the top rail of a first coupled inductor of the plurality of coupled inductors is coupled with the bottom rail of a second coupled inductor of the plurality of coupled inductors;
   the top rail of the second coupled inductor is coupled with the bottom rail of a third coupled inductor of the plurality of coupled inductors;
   the top rail of the third coupled inductor is coupled with the bottom rail of a fourth coupled inductor of the plurality of coupled inductors; and
   the top rail of the fourth coupled inductor is coupled with the bottom rail of the first coupled inductor.
33. The magnetic coupled inductor of clause 32, wherein:
   a face of the first coupled inductor is parallel to a face of the third coupled inductor;
   a face of the second inductor is parallel to a face of the fourth coupled inductor; and
   the faces of the first and third coupled inductors are perpendicular to the faces of the second and fourth coupled inductors.
34. The multiphase coupled inductor of clause 27, further comprising a cap layer between a first coupled inductor of the plurality of coupled inductors and a second coupled inductor of the plurality of coupled inductors, wherein the cap layer extends in the first direction.
35. The multiphase coupled inductor of clause 34, wherein the cap layer is coupled with the first coupled inductor and the second coupled inductor.
36. The multiphase coupled inductor of clause 34, wherein the cap layer is between a face of the first coupled inductor and a face of the second coupled inductor.
37. The multiphase coupled inductor of clause 27, wherein for each of the plurality of coupled inductors, an adjustment of a length of the top rail and a length of the bottom rail allows an adjustment of a leakage inductance of the multiphase coupled inductor.
38. The multiphase coupled inductor of clause 27, wherein for each of the plurality of coupled inductors:
   the top rail and the bottom rail each comprises a portion extending in a second direction normal to the first direction, the portion of the top rail and the portion of the bottom rail extending towards each other.
39. The multiphase coupled inductor of clause 38, wherein for each of the plurality of coupled inductors:
   the portion of the top rail extending in the second direction and the portion of the bottom rail extending in the second direction are spaced apart from each other.
40. The multiphase coupled inductor of clause 27, wherein for each of the plurality of coupled inductors:
   the top rail and the bottom rail of extend in the first direction past the at least one rung.
41. A method of forming a multiphase coupled inductor, the method comprising:
   forming a magnetic ladder core assembly by:
      forming a first row of electrical windings along a first direction by winding an electrically conducting coil around each rung of a first row of at least one rung; and
      forming a second row of electrical windings along the first direction by winding an electrically conducting coil around each rung of a second row of at least one rung,
      wherein the first and the second row of electrical windings are separated by a middle rail having a width along a second direction normal to the first direction.
42. A method of forming a multiphase coupled inductor, the method comprising:
   forming a first coupled inductor; and
   forming a second coupled inductor, wherein forming each of the first and the second coupled inductors comprise:
      forming a magnetic ladder core comprising:
         a top rail extending along a first direction;
         a bottom rail parallel to the top rail and extending along the first direction;
         at least one rungs between the top and the bottom rails, wherein adjacent rungs of the at least one rung are separated by a void; and
         winding an electrically conducting coil around each rung of the at least one rung to form a row of electrical windings; and
         combining the first and the second coupled inductors such that the bottom rail of the first coupled inductor merges with the top rail of the second coupled inductor to form a middle rail of the multiphase coupled inductor.

What is claimed is:

1. A multiphase coupled inductor, comprising:
a magnetic ladder core assembly, comprising:
a first row of at least one rung, wherein an electrically conductive winding is wound around each rung of the at least one rung, forming a first row of electrical windings along a first direction;
a second row of at least one rung, wherein an electrically conductive winding is wound around each rung of the at least one rung, forming a second row of electrical windings along the first direction; and
a middle rail having a width along a second direction normal to the first direction, separating the first and the second row of electrical windings.

2. The multiphase coupled inductor of claim 1, wherein the magnetic ladder core assembly further comprises a top rail formed above the middle rail such that the first row of electrical windings is located between the top rail and the middle rail.

3. The multiphase coupled inductor of claim 2, wherein the magnetic ladder core assembly further comprises a bottom rail formed below the middle rail such that the second row of electrical windings is located between the middle rail and the bottom rail.

4. The multiphase coupled inductor of claim 1, wherein a coupling coefficient between windings within a row of electrical windings is higher than a coupling coefficient between the first and the second rows of electrical windings.

5. The multiphase coupled inductor of claim 1, wherein a coupling coefficient between adjacent windings in the first direction is higher than a coupling coefficient between corresponding adjacent windings in the second direction.

6. The multiphase coupled inductor of claim 1, further comprising a plurality of magnetic ladder core assemblies forming a two-dimensional grid pattern.

7. The multiphase coupled inductor of claim 1, wherein the windings in the first and the second rows of the electrical windings form a tessellating pattern.

8. The multiphase coupled inductor of claim 1, wherein an adjustment of the width of the middle rail allows an adjustment of a leakage inductance of the multiphase coupled inductor.

9. The multiphase coupled inductor of claim 8, wherein the magnetic ladder core assembly further comprises a cap layer, and wherein the cap layer is configured to further adjust the leakage inductance of the multiphase coupled inductor.

10. The multiphase coupled inductor of claim 1, wherein an adjustment of the width of the middle rail allows an adjustment of an alternating current (AC) flux density within the middle rail.

11. The multiphase coupled inductor of claim 1, wherein the first and the second rows of electrical windings and the middle rail are coplanar.

12. The multiphase coupled inductor of claim 3, wherein the top rail, the middle rail, the bottom rail, the first row of the at least one rung, and the second row of the at least one rung are made from similar magnetic materials, or wherein at least two of the top rail, the middle rail, the bottom rail, the first row of the at least one rung, and the second row of the at least one rung are made from dissimilar magnetic materials.

13. A power converter comprising the multiphase coupled inductor of claim 1.

14. A multiphase coupled inductor, comprising:
a first coupled inductor; and
a second coupled inductor, wherein each of the first and the second coupled inductors comprise:
a magnetic ladder core comprising:
a top rail extending along a first direction;
a bottom rail parallel to the top rail and extending along the first direction;
at least one rung between the top and the bottom rails, wherein adjacent rungs of the at least one rung are separated by a void; and
an electrical winding around each rung of the at least one rung to form a row of electrical windings,
wherein the first and the second coupled inductors are combined such that the bottom rail of the first coupled inductor merges with the top rail of the second coupled inductor to form a middle rail of the multiphase coupled inductor, and
wherein the middle rail has a width along a second direction normal to the first direction.

15. The multiphase coupled inductor of claim 14, wherein the first and the second coupled inductors comprise a four-phase coupled inductor, or wherein the first and the second coupled inductors are merged to form an eight-phase coupled inductor.

16. The multiphase coupled inductor of claim 14, comprising a plurality of four-phase coupled inductors arranged in a two-dimensional grid pattern, and wherein the plurality of four-phase coupled inductors is coplanar.

17. The multiphase coupled inductor of claim 14, wherein the middle rail of the multiphase coupled inductor has a width along a second direction normal to the first direction, and wherein an adjustment of the width of the middle rail allows an adjustment of a leakage inductance of the multiphase coupled inductor.

18. The multiphase coupled inductor of claim 17, wherein the magnetic ladder core comprises a cap layer, and wherein the cap layer is configured to further adjust the leakage inductance of the multiphase coupled inductor.

19. The multiphase coupled inductor of claim 14, wherein an adjustment of the width of the middle rail allows an adjustment of alternating current (AC) flux density within the middle rail.

20. A power converter comprising the multiphase coupled inductor of claim 14.
